(19) United States
(12) Patent Application Publication
(10) Pub. No.: US 2025/0224178 A1
(43) Pub. Date: Jul. 10, 2025

(54) SEAL ARRANGEMENT OF A ROTARY KILN

(71) Applicant: EagleBurgmann Germany GmbH & Co. KG, Wolfratshausen (DE)

(72) Inventors: Stefan Danner, Arzbach (DE); Markus lttner, Lechbruck (DE); Alfred Matuschek, Geretsried (DE)

(73) Assignee: EagleBurgmann Germany GmbH & Co. KG, Wolfratshausen (DE)

(21) Appl. No.: 18/850,662

(22) PCT Filed: Feb. 7, 2023
(86) PCT No.: PCT/EP2023/052994

§ 371 Date: Sep. 25, 2024

(30) Foreign Application Priority Data
Apr. 14, 2022 (DE) 10 2022 109 305.0

(51) Int. Cl. F27B 7/24; F27D 99/00

(52) U.S. Cl. CPC F27B 7/24; F27D 99/0073

(57) ABSTRACT

The invention relates to a sealing arrangement of a rotary kiln for sealing on a rotary tube, comprising a first and a second seal half (10, 20) and a first and a second traction system (3, 4), wherein the two seal halves (10, 20) exert a tensile force (F) for sealing on an outer periphery of the rotary tube, by means of the two traction systems (3, 4).

The present invention relates to a sealing arrangement of a rotary kiln, which seals an outer periphery of a rotating part of the rotary kiln, and to a rotary kiln comprising a sealing arrangement according to the invention.

Rotary kilns are widely used in the process industry, for example in the chemical industry or the cement industry. In this case, there is the problem of sealing a rotating rotary tube with respect to the surroundings. For this purpose, a sealing arrangement is arranged on an outer periphery of the rotary tube. In order to ensure function of the rotary kiln without problem, very high requirements must be placed on the sealing arrangements. However, this makes the sealing arrangements relatively complex and expensive.

The object of the present invention is therefore that of providing a sealing arrangement of a rotary kiln, and a rotary kiln, which, with a simple design and simple, cost-effective manufacturability, allows for reliable operation of the rotary kiln over a long operating period.

This object is achieved by a sealing arrangement of a rotary kiln having the features of claim 1, and a rotary kiln having the features of claim 13. The dependent claims each show preferred developments of the invention.

The sealing arrangement of a rotary kiln according to the invention, for sealing a rotating component of the rotary kiln, in particular a rotary tube, having the features of claim 1, has the advantage that construction is very simple and therefore cost-effective. Furthermore, it is possible that identical parts can be used, as a result of which the costs for producing the sealing arrangement can be further reduced. Nonetheless, reliable sealing on a rotating part of the rotary kiln can be ensured, and thus a loss of energy and product to the atmosphere can be prevented. A further significant advantage of the sealing arrangement according to the invention is that relative movements both in the radial and in the axial direction can also be absorbed. This can take place during operation of the rotary kiln, on account of thermal influences during operation. This is achieved according to the invention in that the sealing arrangement comprises a first and a second seal half. The first seal half comprises a first sealing cord and a first retaining structure having a first and second lateral retaining ring element, wherein in each case one retaining ring element is arranged on an axial side of the first sealing cord. The second seal half comprises a second sealing cord and a second retaining structure having a first and second lateral retaining ring element, wherein the second sealing cord is arranged between the two retaining ring elements. Furthermore, a first and a second traction system are provided. The first traction system is configured to preload the first seal half by means of a tensile force F on the rotating component. The second traction system is configured to preload the second seal half by means of a tensile force F on the rotating component. The tensile forces of the first and second traction system are preferably of the same magnitude. Furthermore, the first and the second seal half of the sealing arrangement are arranged offset in the axial direction in such a way that a first and second axial overlap region results. At the overlap regions, the first and second sealing cords are guided side-by-side. In order to ensure sealing also in the axial direction, at the overlap region, the sealing arrangement further comprises a first and a second fixing element which fixes the first and second seal half at the overlap regions, in the axial direction.

Thus, the sealing arrangement provides sealing in the radial direction on a rotary tube, on the outer periphery of the rotary tube, and additionally provides axial sealing at the two overlap regions. Thus, the rotary tube, which rotates during operation of the rotary kiln, can be reliably sealed with respect to stationary components of the rotary kiln. In this case, the first and second sealing cord wrap around the rotary tube on the outer periphery, wherein each sealing cord preferably seals a sealing region on the rotary tube of 180° in the radial direction. Furthermore, the first and second traction system are preferably configured identically. This allows for a reduction in the complexity of the sealing arrangement by the plurality of identical parts.

Preferably, the overlap regions of the two seal halves are opposite one another.

Further preferably, the sealing arrangement further comprises contact sealing rings which are arranged axially between the sealing cords and the retaining structures. The contact sealing rings are thus in direct contact with the sealing cords. The contact sealing rings are preferably metal, in particular produced from bronze, brass or PTFE. In this case, the contact sealing rings are preferably arranged such that the sealing cords protrude slightly beyond the contact sealing rings towards the inside in the radial direction. Sealing of the rotary tube on the outer periphery thus takes place by the contact between the rotary tube and the sealing cords. Should wear occur on the sealing cords, the contact sealing rings additionally come into contact with the outer periphery of the rotary kiln. In this case, the sealing cords can now be replaced, or alternatively the rotary kiln is operated further, such that the contact sealing rings which are now, together with the sealing cords, in contact with the outer periphery of the rotary tube, also wear. After a certain operating time, then, in addition to the sealing cords, the contact sealing rings must also be replaced.

The contact sealing rings are preferably rigidly connected to the sealing cords, for example by pins which are guided through the sealing cords.

In order to ensure a structure that is as simple as possible, the contact sealing rings are preferably constructed from a plurality of ring segments. The ring segments are preferably configured identically, and preferably comprise a curved projection in the peripheral direction, at one end, and a curved recess, configured in a manner corresponding to the curved projection, at the other end.

The traction systems preferably each comprise a fixed bearing at one end of the sealing cords and a traction device at the other end of the sealing cords. As a result, a particularly simple and cost-effective structure can be achieved. Alternatively, the traction systems each comprise traction devices at both ends of the sealing cords.

The traction devices preferably each comprise a compression spring, e.g. a cylinder spring or leaf spring, which is configured to exert the tensile force F on the sealing cords. In this case, the compression spring is preferably arranged between a stationary support and a nut that is connected to the tension rod. The tension rod preferably comprises a thread, such that the preload can be set by twisting the nut on the threaded rod, which is connected to a sealing cord.

In order to allow for the simplest possible fixing at the overlap regions, the first and second fixing elements each comprise two plates, which are detachably interconnected. The plates can be interconnected for example by screws or the like. The plates are particularly preferably part of a housing of the sealing arrangement.

For improved absorption of axial movements of the rotary tube, the sealing arrangement further preferably comprises preload elements which exert a preload on the first and second seal half, in the axial direction.

Further preferably, support elements are arranged on the outer periphery of the first and second sealing cords, which support elements prevent a relative movement between the two sealing cords and the contact elements. The support elements are preferably pins, which are preferably fixed to the retaining ring elements of the retaining structures. Thus, the sealing cords and the contact elements follow radial movements of the pressure pipe together, if the pressure pipe performs such radial movements during operation.

Further preferably, the sealing arrangement comprises support arms, on which the traction systems are arranged. The support arms are particularly preferably part of a housing of the sealing arrangement.

In order to be able to measure wear of the sealing arrangement, the two traction systems preferably comprise wear indicators. These wear indicators can for example be measuring scales, which are arranged on the tension rod of the traction systems.

The present invention further relates to a rotary kiln comprising a rotary tube and a sealing arrangement according to the invention.

Preferred embodiments of the invention are described in detail in the following with reference to the accompanying drawings, in which:

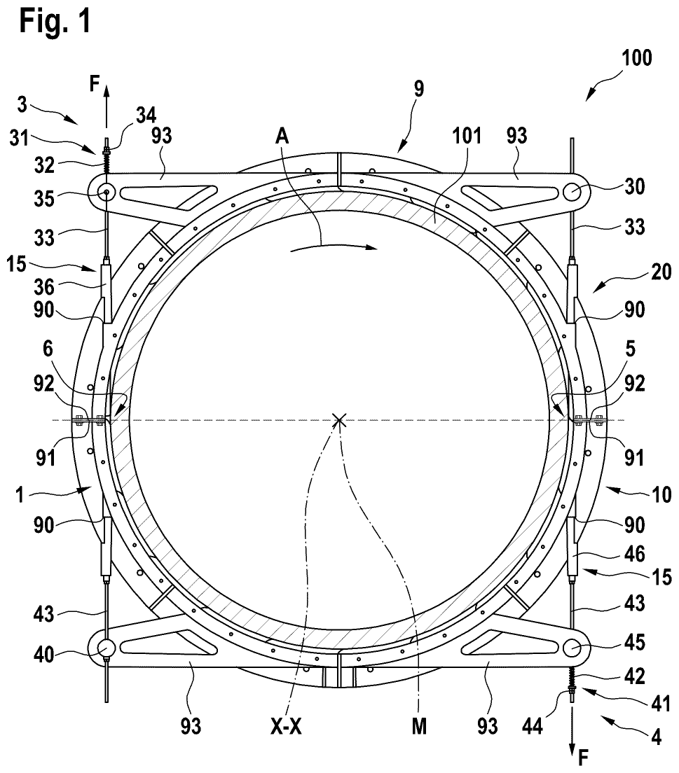

FIG. 1 is a schematic plan view, in the axial direction, of a sealing arrangement on a rotary tube of a rotary kiln,

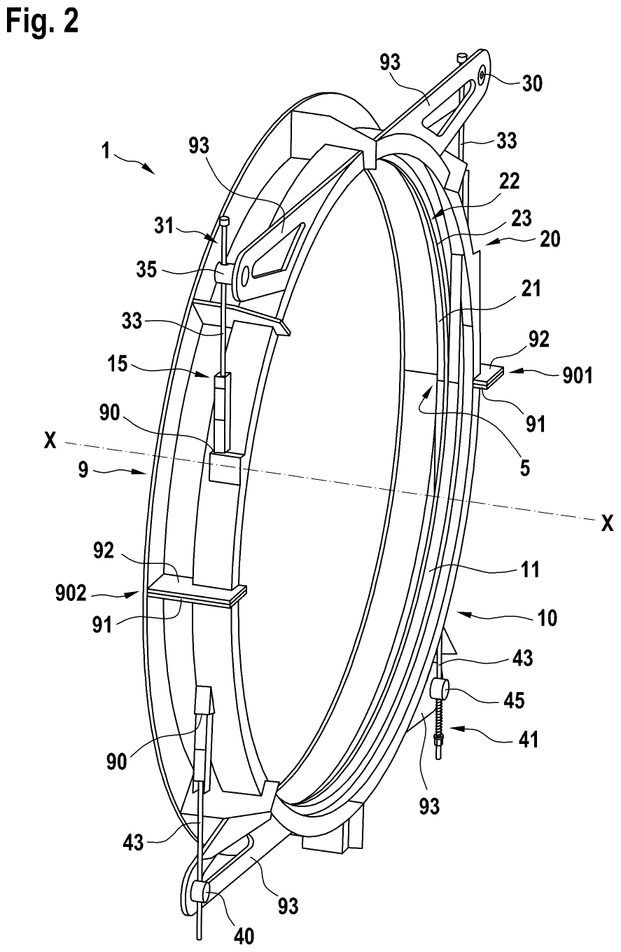

FIG. 2 is a perspective view of the sealing arrangement of FIG. 1,

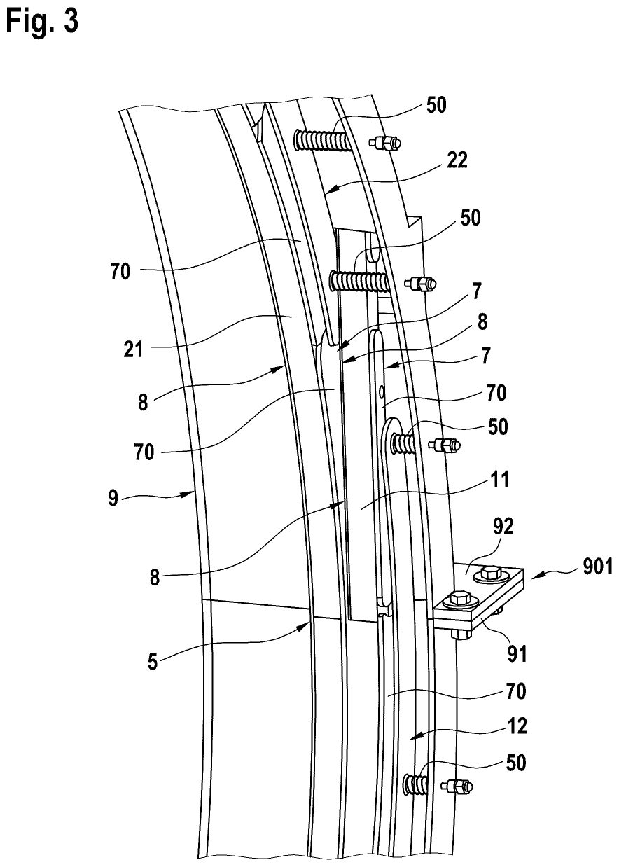

FIG. 3 is a perspective, enlarged partial view of the sealing arrangement of FIG. 1,

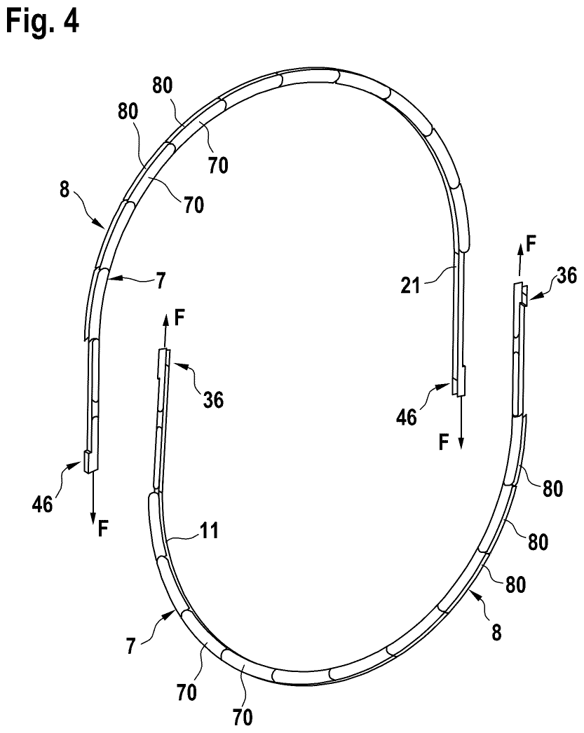

FIG. 4 is a schematic view of sealing cords of the sealing arrangement of FIG. 1,

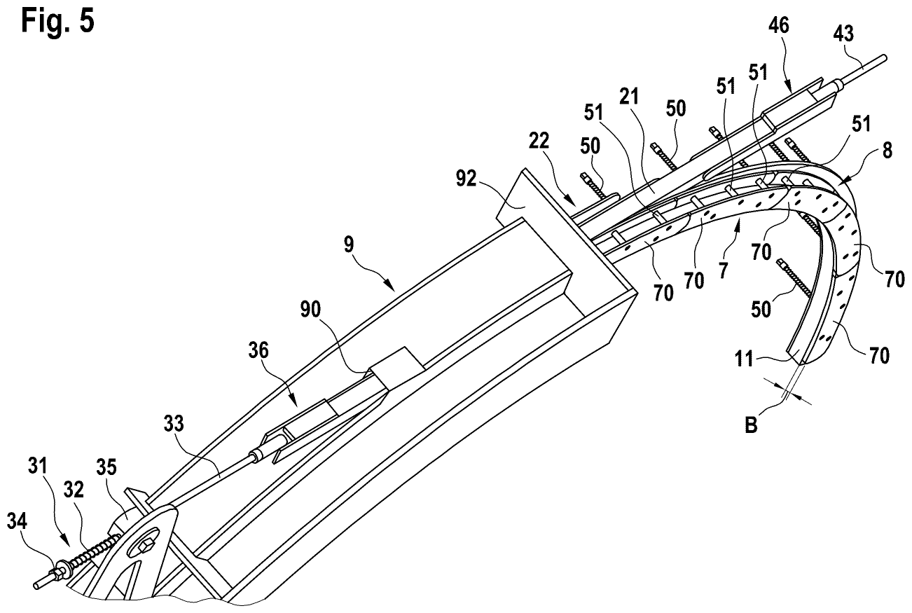

FIG. 5 is a schematic, perspective partial view of the sealing arrangement of FIG. 1,

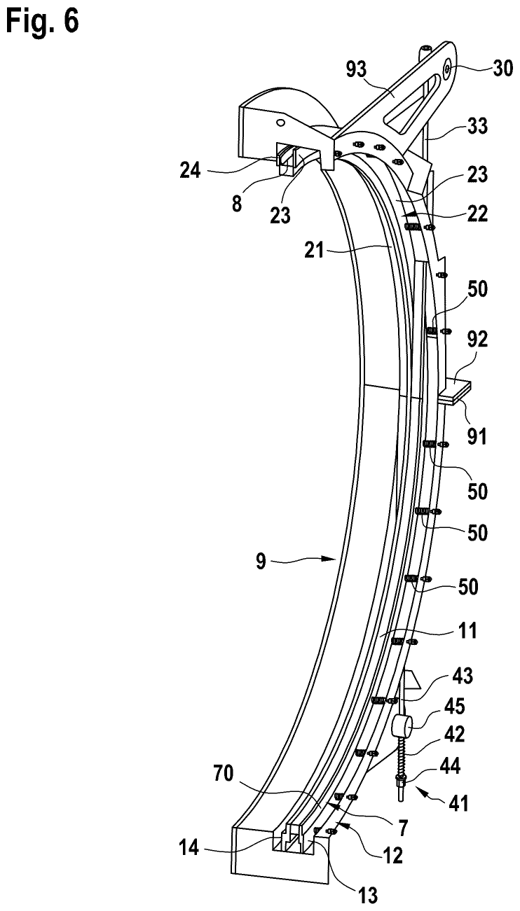

FIG. 6 is a schematic, perspective view of part of the sealing arrangement of FIG. 1,

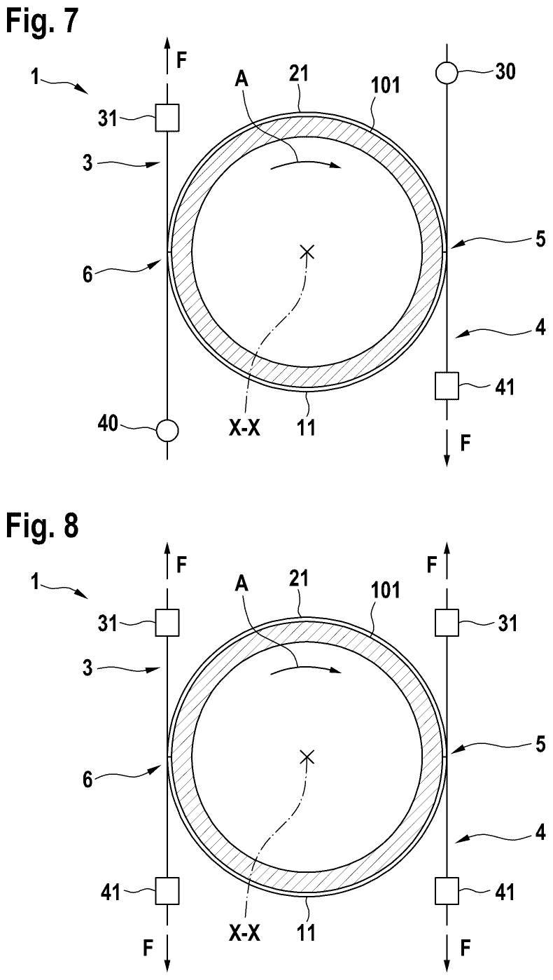

FIG. 7 is a schematic view of the function of the traction systems of the sealing arrangement of FIG. 1, and

FIG. 8 is a schematic view of the traction systems of an alternative sealing arrangement.

A sealing arrangement 1 according to a preferred embodiment of the invention is described in detail in the following, with reference to FIG. 1 to 7. The sealing arrangement 1 is arranged on an outer periphery of a rotating rotary tube 101 of a rotary kiln 100. The arrow A symbolizes a rotation of the rotary tube 101.

The sealing arrangement 1 is arranged in a stationary manner and does not rotate with the rotary tube 101.

The sealing arrangement 1 for sealing on the rotary tube 101 comprises a first seal half 10 and a second seal half 20. The two seal halves 10, 20 are configured to be substantially identical. In this case, the two seal halves are point-reflected at a centre M of the sealing arrangement. A central axis X-X extends through the centre M, in the axial direction of the sealing arrangement.

The first seal half 10 comprises a first sealing cord 11 and a first retaining structure 12. In this case, the first retaining structure 12 comprises a first retaining ring element 13 and a second retaining ring element 14.

The second seal half 20 is configured identically to the first seal half 10 and comprises a second sealing cord 21 and a second retaining structure 22. The second retaining structure 22 also comprises a first and second retaining ring element 23, 24. In each case one retaining ring element 23, 24 is arranged on an axial side of the second sealing cord 21.

The sealing arrangement 1 further comprises a first traction system 3 and a second traction system 4. The two traction systems 3, 4 are configured to exert a tensile force F on the first and second sealing cord 11, 21. Thus, the two traction systems 3, 4 preload the two sealing cords 11, 21 radially on the rotary tube 101, in order to provide a sealing effect on the outer periphery of the rotary tube. In this case, the sealing effect is provided both in the case of a stationary and in the case of a rotating rotary tube 101.

Furthermore, the first and the second seal half 10, 20 are arranged offset in the axial direction of the sealing arrangement, in such a way that a first overlap region 5 and a second axial overlap region 6 results. The offset arrangement of the two sealing cords 11, 21 thus allows for radial sealing on the inside periphery of the sealing cords, on the rotary tube, and also axial sealing between the two sealing cords 11, 21, at the two overlap regions. This is shown in particular in FIG. 2, by way of example, on the basis of the first overlap region 5, on which the first and second sealing cord 11, 21 extend side-by-side for a short distance.

In order to ensure the axial sealing at the two overlap regions 5, 6, the sealing arrangement further comprises a first fixing element 901 on the first overlap region 5 and a second fixing element 902 on the second overlap region 6. The two fixing elements 901, 902 fix the two seal halves 10, 20, and are configured to be U-shaped in cross-section, such that the first and second sealing cords are held in the axial direction.

The first retaining structure 12 and the second retaining structure 22 thus form an annular frame, wherein the sealing cords 11, 21 are arranged between the retaining ring elements 13, 14 and 23, 24. The retaining ring elements can preferably be part of a housing 9.

The fixing elements 901, 902 can also be part of the housing 9 of the sealing arrangement 1.

The sealing arrangement 1 furthermore also comprises a first and second contact sealing ring 7, 8 on each seal half 10, 20. As can be seen in particular from FIGS. 3, 4 and 5, in each case a contact sealing ring 7, 8 is arranged on an axial side of the sealing cords 11, 21. In this case, the contact sealing rings 7, 8 are constructed from a plurality of ring segments 70, 80.

The ring segments 70, 80 are visible in detail from FIG. 4 and comprise a curved projection at one end and a curved recess, configured in a manner corresponding to the curved projection, at the other end. This can allow for a tight arrangement of the ring segments.

As is visible in particular from FIG. 5, the sealing cords 11 and 21 protrude slightly from the contact sealing rings 7, 8, radially towards the inside, by an amount B. This ensures that, in the mounted (new) state, the sealing cords 11, 21 rest on the outer periphery of the rotary tube 101.

In order to prevent a relative movement of the first and second sealing cord 11, 21 and the contact sealing rings 7, 8, in the radial direction, a plurality of support elements 51 in the form of small pins is provided. The pins are preferably in each case arranged between the first and second contact sealing ring 7, 8 (cf. FIG. 5).

Furthermore, a plurality of axial preload elements 50 is also arranged along the periphery, which elements exert an axial force on the outer contact sealing rings.

Thus, during operation of the rotary tube, firstly the sealing cords 11, 21 come into direct sealing contact with the outer periphery of the rotary tube. If, after a certain time, wear occurs on the inner surfaces of the sealing cords 11, 21, the edge regions of the first and second contact sealing rings 7, 8 of the two seal halves 10, 20 also come into contact with the outer periphery of the rotary tube. A user of the sealing arrangement according to the invention can then decide whether they wish to only exchange the sealing cords 11, 21 or to continue to operate the rotary kiln, such that wear also occurs at the inside edges of the first and second contact sealing rings 7, 8. Thus, if the rotary kiln is operated further, in addition to the sealing at the inside periphery of the sealing cords 11, 21, further sealing also takes place at the edges of the first and second contact sealing rings 7, 8.

During further operation of the rotary kiln, the inner surfaces of the sealing cords 11, 21 and the inside edges of the contact sealing rings 7, 8 then wear together. After a certain degree of wear, the sealing cords and the contact sealing rings must then be replaced together.

As can be seen from the schematic view of FIG. 7, the sealing arrangement 1 of this embodiment comprises two traction systems 3, 4. The first traction system 3 comprises a traction device 31 and a fixed bearing 30, between which the first sealing cord 11 extends. The second traction system 4 comprises a fixed bearing 40 and a traction device 41, between which the second sealing cord 21 extends. Thus, each traction system 3, 4 comprises a fixed bearing and a traction device.

The first and second traction device 31, 41 are configured identically. FIG. 6 shows the second traction device 41 in detail, which device comprises a compression spring 42 which is arranged around a tension rod 43, a nut 44, and a stationary support 45. A drilled hole for passing through the tension rod 43 is formed in the support 45. The tension rod also comprises a thread, on which the nut 44 is adjustably screwed. In this case, the preload force of the traction device 41 can be set by adjusting the position of the nut. Since the compression spring is arranged between the stationary support 45 and the nut 44, this can be configured as a compression spring.

Preferably a wear indicator 15, for example a scale (not shown in detail) is additionally also arranged on the traction device, by means of which wear of the sealing arrangement can be displayed, since in the case of wear on the components in contact with the rotary tube the position of the tension rod 43 changes on account of the compression spring 42.

The first traction device 31, which is arranged diametrically opposite the second traction device 41 (cf. FIGS. 1 and 2) is configured identically to the second traction device 41. The first traction device 31 comprises a compression spring 32, a tension rod 33 having a thread, a nut 34 screwed on the thread, and a stationary support 35.

For connection between the first traction device 31 and the first sealing cord 11, a connecting piece 36 is provided (cf. FIGS. 4 and 5). In the same way, a connecting piece 46 is also provided between the second traction device 41 and the second sealing cord 21 (cf. FIGS. 4 and 5).

As can be seen schematically from FIG. 5, four through-openings 90 are provided in the annular housing 9, in order to guide the respective ends of the sealing cords 11, 21 out of the housing to the outside, in the direction towards the support arms 93. The support arms 93 are arranged on the outside of the housing 9 and serve for fastening the first and second traction devices 31, 41. The fixed bearings 30, 40 of the traction systems 3, 4 are arranged on the other two support arms 93.

FIG. 8 shows an alternative embodiment of the invention, in which the traction systems 3, 4 in each case comprise additional traction devices instead of the fixed bearings. Thus, the first traction system 3 comprises two traction devices 31, in each case at the ends of the sealing cord 11, and the second traction system 4 comprises two traction devices 41 at the ends of the second sealing cord 21 (cf. FIG. 8).

However, as can be seen from a comparison of FIGS. 7 and 8 the sealing principles are the same in the two alternative embodiments if, instead of the fixed bearing, a further traction device is arranged.

Thus, the sealing arrangement 1 according to the invention can enable reliable sealing on a rotating rotary tube 101 of a rotary kiln 100. In principle, in this case, sealing can also take place in both directions of rotation of the rotary tube 101, without additional leaks or the like resulting. The performance of the seal is identical in both directions of rotation. In order to stiffen the sealing arrangement, furthermore a plurality of cross members or flanges or the like can be provided on the housing. In the case of wear having occurred, in the case of the sealing arrangement according to the invention actually only the sealing cords 11, 21 and possibly the contact sealing rings 7, 8 have to be replaced. In this case, the traction systems 3, 4 and the further components of the sealing arrangement 1 can be reused.

The axially offset arrangement of the first and second sealing cord 11, 21 also enables radial sealing on the entire periphery of the rotary tube. In addition, axial sealing also takes place at the two transition regions 5, 6, which sealing is maintained by the first and second fixing elements 901, 902. Wear of the sealing arrangement can furthermore be easily read off on the traction systems 3, 4 located outside the housing, for example on a scale.

In addition to the above written description of the invention, for the additional disclosure thereof reference is hereby explicitly made to the illustrative drawings of the invention in FIG. 1 to 8.

### LIST OF REFERENCE CHARACTERS

1 sealing arrangement
3 first traction system
4 second traction system
5 first overlap region
6 second overlap region
7 first contact sealing ring
8 second contact sealing ring
9 housing
10 first seal half
11 first sealing cord
12 first retaining structure
13 first retaining ring element
14 second retaining ring element
15 wear indicator
20 second seal half
21 second sealing cord
22 second retaining structure
23 first retaining ring element
24 second retaining ring element
30 fixed bearing
31 first traction device
32 compression spring
33 tension rod
34 nut
35 support
36 connecting piece
40 fixed bearing
41 second traction device
42 compression spring
43 tension rod
44 nut
45 support
46 connecting piece
50 axial preload elements
51 support elements/pins
70 ring segments
80 ring segments
90 through-opening
91 first plate
92 second plate
93 support arm
100 rotary kiln
101 rotating rotary tube
901 first fixing element
902 second fixing element
A direction of rotation
B distance between edge of the contact sealing rings 7, 8 and the inside periphery of the sealing cords
F tensile force
M centre
X-X central axis

1. Sealing arrangement of a rotary kiln for sealing on a rotating rotary tube, comprising
a first seal half having a first sealing cord and a first retaining structure, wherein the first retaining structure comprises a first retaining ring element and a second retaining ring element, and wherein in each case one retaining ring element is arranged on an axial side of the first sealing cord,
a second seal half having a second sealing cord and a second retaining structure, wherein the second retaining structure comprises a first lateral retaining ring element and a second lateral retaining ring element, and wherein in each case one retaining ring element is arranged on an axial side of the second sealing cord,
a first traction system, which is configured for preloading the first seal half by means of a tensile force on an outer periphery of the pressure pipe, on the pressure pipe,
a second traction system, which is configured for preloading the second seal half by means of a tensile force (F) on the outer periphery of the pressure pipe,
wherein the first seal half and the second seal half are arranged so as to be offset from one another in the axial direction, in such a way that a first overlap region and a second overlap region is formed on the periphery of the sealing arrangement, wherein the first and second sealing cord extend side-by-side on the first and second overlap region, and
a first fixing element on the first overlap region, which fixes the regions of the first and second sealing cord, located on the first overlap region, in the axial direction, and a second fixing element on the second overlap region, which fixes the regions of the first and second sealing cord, located on the second overlap region, in the axial direction.

2. Sealing arrangement according to claim 1, further comprising contact sealing rings which are arranged axially between the sealing cords and the retaining structures.

3. Sealing arrangement according to claim 2, wherein each contact sealing ring is constructed from a plurality of ring segments.

4. Sealing arrangement according to claim 1,
wherein the first and second traction system each comprise a fixed bearing at a first end of the sealing cords and a traction device at the other second end of the sealing cords, or
wherein the traction systems comprise traction devices at both ends of the sealing cords.

5. Sealing arrangement according to claim 4, wherein the traction devices each comprise a compression spring which is configured to exert the tensile force on the sealing cords.

6. Sealing arrangement according to claim 5, wherein the traction device further comprises a tension rod comprising a thread, a nut and a stationary support, wherein the compression spring is arranged around the tension rod and is arranged between the nut and the support.

7. Sealing arrangement according to claim 1, wherein the first and second fixing element each comprises a first plate and a second plate which are detachably interconnected.

8. Sealing arrangement according to claim 7, wherein the first and second fixing element is part of an annular housing of the sealing arrangement.

9. Sealing arrangement according to claim 1, further comprising preload elements which are configured for exerting a preload, in the axial direction, on the sealing cords.

10. Sealing arrangement according to claim 1, further comprising support elements which are arranged on the outer periphery of the first sealing cord and of the second sealing cord, in order to prevent a relative movement between the sealing cords and the contact sealing rings.

11. Sealing arrangement according to claim 10, wherein the support elements are pins which are fixed between the contact sealing rings.

12. Sealing arrangement according to claim 1, further comprising support arms on which the traction systems are arranged.

13. Sealing arrangement according to claim 1, wherein the traction systems comprise wear indicators for indicating wear of the sealing cords.

14. Rotary kiln comprising a rotary tube and a sealing arrangement according to claim 1, which seals on an outer periphery of the rotary tube.
